(19) United States
(12) Patent Application Publication
(10) Pub. No.: US 2002/0077719 A1
(43) Pub. Date: Jun. 20, 2002

(54) Variable parameter controls for semiconductor processes

(76) Inventor: Howard G. Hao, Toronto (CA)

Correspondence Address: HOWARD G. HAO, 21920 EATON PL., CUPERTINO, CA, 95014, US

(21) Appl. No.: 09/740,340

(22) Filed: Dec. 18, 2000

(51) Int. Cl. G06F 19/00

(52) U.S. Cl. 700/117

(57) ABSTRACT

The invention introduces variable process parameters to define and control the processes. Process parameters can be defined as variables with processing time to compensate process condition changes caused by hardware changes and process environment changes. Equipment is to be designed such that the main parameters are adjustable in the processes for compensation and control needs. The adjustment for the main parameters can be performed by real time measurement and control, dynamic characteristics generated by analytical analysis, experimental data, and or simulation. These compensations or adjustments are either imbedded in the hardware and control system or appeared to parameter control windows. These compensations or adjustments are performed among substrates and/or within a substrate. Using these techniques, substrates are processed to produce substantially uniform process results.

The process chamber conditions can be controlled by main parameters such as pressure, temperature, gas flow, RF power, electrical parameters, optical signals, and/or processing time. Another process control parameter can be chamber volume. Process chamber volume can be controlled by changing one of the parameter of the volume components such as the distance between a substrate and the chamber component opposite to it.

### BACKGROUND OF THE INVENTION

1. Field of the Invention

The present invention relates to methods and techniques for processing substrates such as semiconductor substrates for use in intergraded circuit fabrication or flat panels. More specifically, the present invention relates to methods and techniques for dynamically controlling processes with a high degree of accuracy from substrate to substrate.

2. Background of the Invention

Plasma processing systems utilizing capacitive coupled plasma sources, inductive coupled plasma sources, wave-heated plasma sources, and the like, have been introduced and employed to various degrees to process semiconductor substrates and display panels. For manufacturing those products, multiple deposition and/or etching steps may be employed. During deposition, materials are deposited onto a substrate surface. For example, deposited layers such as various forms of silicon dioxide, silicon nitride, tungsten, copper, polysilicon, and the like may be formed on the surface of the substrate. During etching, selected materials are removed from predefined areas on the substrate surface. For example, etched features such as dual damansine, contacts, vias, or trenches may be produced in the substrates.

In FIG. 1, a conventional plasma processing system 100 is shown. Chamber 130 consists of upper chamber 140 and lower chamber 150. A substrate 110 to be processed is placed on a substrate pedestal 120 inside a process chamber 130 and process gases 180 are fed into the process chamber 130. RF generator supplies power 190 to the electrode(s) 160 to ignite plasma 170 inside the process chamber 130. After ignition, the plasma is further sustained with RF energy and suitable conditions.

Plasma etch mechanisms consist of chemical reaction and ion bombardment. The etching rate and geometry of the etched openings are related to the energy of the ion and the rate of chemical reaction.

Plasma etching is a key process for removing material from surfaces. The process can be chemically selective, removing one type of material while leaving other materials unaffected, and can be anisotropic, removing material at the bottom of a trench, while leaving the same material on the sidewall unaffected. Plasma etching is the only commercially viable technology for anisotropic removal of material from surfaces. It is an indispensable part of modem integrated circuit fabrication technology. Hence, such processes need to be controlled to produce substrate-to-substrate process uniformity.

Current approaches for controlling a semiconductor process are static with constant process parameters for each process. Process parameters include substrate area pressure, electrode/chamber temperature, processing time, gas flow rate, and RF power. Conventional substrate area pressure is controlled by some components and/or mechanisms. The mechanisms change the size of the flow passage and cause the change of conductance; therefore, change the substrate area pressure. [Patent E. Lenz, patent F. Hao]. Generally, a single or dual channel chiller controls temperature. Given single or dual temperature set points the chiller can control/maintain the temperatures to specified temperatures.

Conventional processes use a single recipe for each process. Every substrate uses the same recipe for a process in a processing tool. The recipe does not account for the differences from tool to tool, and the difference of a tool itself changing with the processing time.

Recent efforts have been made in the process controls for examples: U.S. Pat. No. 5,167,009, Online process control neural network using data pointers; U.S. Pat. No. 5,841,660, Method and apparatus for modeling process control; U.S. Pat. No. 5,481,112, Method and apparatus for process controls of material emitting radiation; U.S. Pat. No. 5,293,216, Sensor for semiconductor device manufacturing process control. U.S. Pat. No. 6,041,270 states automatic recipe adjust and download based on process control window. It provides a method of manufacturing semiconductor wafers using a simulation tool to determine a set of predicted wafer electrical test measurements that are compared to a set of target wafer electrical test measurements to obtain a set of optimized process parameters for the equipment for the next process. The optimized process parameters are compared to the equipment characteristics for the equipment of the next process and the process parameters for the next process are automatically adjusted. Such an in-situ simulation and measurement is complicated and not practical for industrial applications.

Hardware (tool-to-tool, chamber-to-chamber) difference results in the difference in process. For instance, a chamber (in side volume) of a new tool is 10 mm in height. If upper chamber assembly tolerance stack up is 0.5 mm max, and lower chamber assembly tolerance stack up is 0.5 mm max, only height tolerance stack up can result in 10% chamber volume change. By adjusting the chamber height to a predefined value, the position of the other chamber related parts will be changed. It is commonly seen that chamber-to-chamber initial conditions are different. It is possible to reduce the tolerance stack up by tightening each related tolerance of related components but the machine will become more expensive. It is impossible to build a tool without tolerance stack ups. Therefore, there always is a tool-to-tool difference. Conventional fix is adjusting, reassembling assemblies, or replacing some chamber parts. All these procedures are tedious, costly, and are not always resolve the problems.

Furthermore, the condition of a tool is changing with process time and the number of the substrates processed. These changes include temperature, pressure, polymer formation in the gas mixture, and polymer deposition on the chamber wall as well as other chamber components. The changes alter the rate of chemical reaction and the plasma characteristics and will eventually be reflected in the product, i.e., the processed substrates. Constantly cleaning and/or reconditioning the chamber after each processe not only reduce the throughput but also not feasible due to more precise substrate processing requirements. The developments of some tools with high-density plasma are discontinued due to the difficulties in obtaining substrate-to-substrate uniformity.

In addition, substrate size increase and feature dimension shrinkage raise the requirements for the process control. For instance, ±10% tolerance for a 3-micron feature size results in ±0.3 micron error size allowance, but ±10% tolerance for a 0.18 micron feature size gives only ±0.018 micron error size allowance. Inaccurate control causes the process drifts; therefore, results in process non-uniformity. It becomes very challenging for semiconductor equipment companies to design equipment to meet the requirements.

In view of the foregoing, there are desired methods and techniques for controlling processes with a high degree of accuracy from substrate to substrate.

### SUMMARY OF THE INVENTION

Broadly speaking, the present invention fills these needs by providing methods and techniques for uniform processes. It should be appreciated that the present invention can be implemented in numerous ways, including as a process, and apparatus, a system, a device, a method, and a computer medium. Several inventive embodiments of the invention are described as below.

In accordance with one embodiment, the invention relates to methods and techniques for processing substrates. The processing system includes a process chamber. The process chamber conditions are controlled by main parameters such as pressure, temperature, gas flow, RF power, electrical parameters, optical signals, and/or processing time. The process parameters can be varied in a process, in a process tool, and/or in a process among the same process tools. The process parameters can be varied in a process among substrates and/or in a substrate. The parameters are to be altered with processing time to compensate the changes of process conditions caused by hardware wears and process environment changes. Equipment is to be designed such that the main parameters are adjustable with processing time for compensation and control needs. The quantities of adjustment for the main parameters are determined by real time measurement and control, dynamic characteristics generated by analysis, experiment, and or simulation. These compensations or adjustments are either imbedded in the hardware and control system or displayed on parameter control windows. These compensations or adjustments are performed between substrates and/or within a substrate. With these techniques, processes will become substantially uniform.

In another embodiment, a method for processing a substrate is presented. The process chamber conditions can be controlled by main parameters such as pressure, temperature, gas flow, RF power, electrical parameters, optical signals, and/or processing time. Another process control parameter can be chamber volume. Process chamber volume can be altered, for instance, by changing the distance between a substrate and the chamber component opposite to the substrate.

### BRIEF DESCRIPTION 0F THE DRAWINGS

The objects and advantages of the invention are illustrated by way of the example, and not by way of limitation. In the figures of the accompany drawings where like reference numerals refer to similar elements, and in which:

FIG. 1 illustrates an exemplary processing chamber.

FIG. 2 illustrates exemplary temperature curves with processing time.

FIG. 3 shows exemplary processing chamber with the etched electrode.

FIG. 4 depicts the distance changes and compensation with processing time.

FIG. 5 illustrates exemplary curves of processing time vs. the etch rate.

FIG. 6 depicts an exemplary curve of RF power vs. etch rate.

FIG. 7 depicts an exemplary temperature discretization.

FIG. 8 illustrates exemplary close loop parameter control compensations.

FIG. 9 illustrates open loop control parameter compensations.

FIG. 10 illustrates exemplary multivariable parameter control compensations.

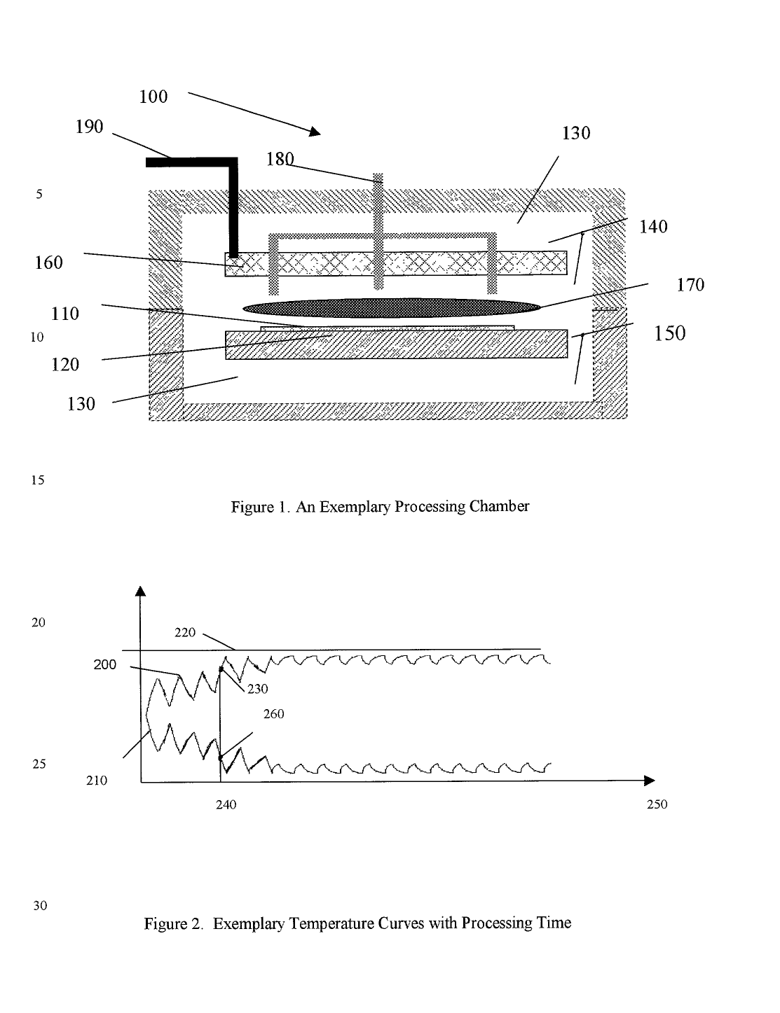

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

According to the present invention, substrate-to-substrate process uniformity can be improved by variable parameter controls. The control can be used in any type of the semiconductor processing apparatus, but not limited to, wherein it is desired to have high process uniformity. Such apparatus includes for dry etching, plasma etching, reactive ion etching, magnetically enhanced etching, CVD system, ashers, capacitive coupled reactors, inductive couples plasma reactors, wave-heated reactors, and the like.

Compensation of System Inherent Problem

FIG. 2 illustrates exemplary curves of the processing time 250 vs. temperature T 200 and temperature difference ΔT 210. The temperature needed is T_{control}220. At tᵢ 240 time, temperature is T_{i,} 230. ΔTᵢ (260)=T_{control}(220)−Tᵢ(230). ΔTᵢ (260) is to be entered to the control system to approximate the temperature needed at time 240. For more accurate control, ΔΔTᵢ is to be used to compensate with the changes of the conditions of the equipment, environment, and other factors. ΔTᵢ=T_{control}−T_{i,} +ΔΔT. By using the variable parameter, the system can approximate the temperature so that uniform process can result.

Compensation of Wear Caused by Processing

In the substrate processing some critical components are wearing away. Worn components will be replaced with the new one. Often these critical components are expensive. The life of those components can be lengthened by adjusting the related system hardware to compensate with the wearing and economical advantage is resulted. Trade off is the cost for adding hardware adjustment mechanism. In addition to the economical benefit, the equipment down time is reduced.

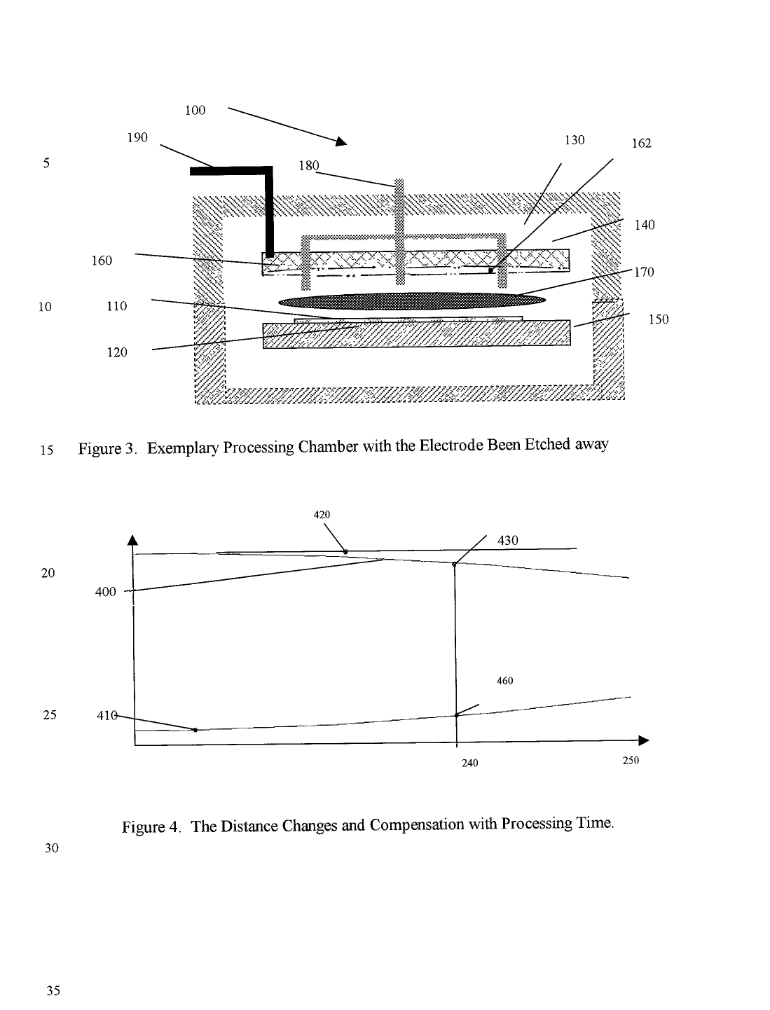

FIG. 3 illustrates an exemplary chamber with an electrode 160. The electrode 160 is etching away 162 during the processes. The distance between the electrode and the substrate is increasing with the process time and so are the process results. Equipment can be designed such that either substrate or electrode can be moved towards each other to compensate the electrode etch and maintain the same distance between the electrode and the substrate. FIG. 4 depicts the averages distance changes and compensations with processing time. Assume the distance needed is d_{control,} 420, the distance measured is 400, and the difference is 410. At t₁ 240 time, distance is d_{i.,} 430. Δdᵢ (460)=d_{control}(420)−dᵢ(430). Δdᵢ 460 is to be entered to the control system to compensate the distance needed at 240, tᵢ time. For more accurate control, ΔΔdᵢ can be used to compensate with the changes of equipment, environment, and other factors. Δdᵢ=d_{control}−d_{i,} +ΔΔd. The variable parameter control, more specifically, the compensation of the distance between the electrode and the substrate will increase the lifetime of the component and maintain uniform processing results.

Variable distance control can also be used as a system pressure control. It is known from gas law that PV/t=const. When distance is reduced, volume reduces and pressure increases.

Etch Rate Compensation

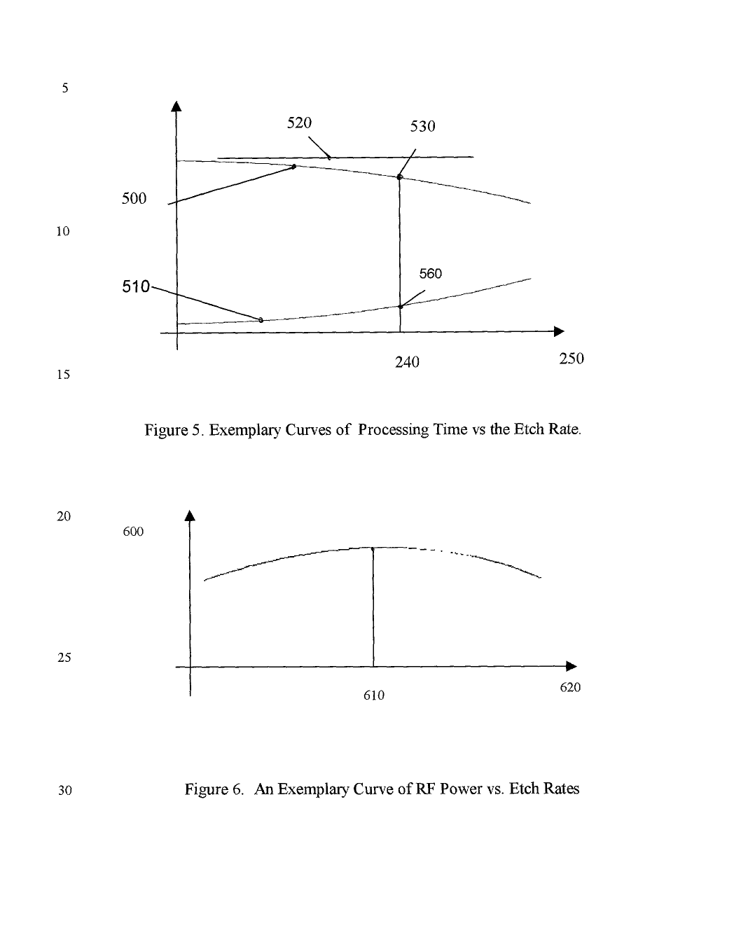

FIG. 5 illustrates exemplary curves of processing time vs. the etch rates. Assume the etch rate needed is E_{control}, 520, the etch rate measured is 500, and the difference is 510. At time tᵢ 240, etch rate is Eᵢ 530. The etch rate difference ΔEᵢ (560)=E_{control}(520)−Eᵢ(530). ΔEᵢ 560 are to be entered to the control system to compensate the distance needed at time tᵢ 240. For more accurate control, ΔΔEᵢ can be used to compensate with the changes of the conditions of equipment, environment, and other factors. ΔEᵢ=E_{control}−E_{i,}+ΔΔE. By using the variable etch rate, lifetime of the components are expanded and uniform process results.

In general processes, etch rate is decreasing with the processing time. By increasing the processing time, the decrease in the etch rate can be compensated. Etch rates are closely connected with chemistry and RF power. FIG. 6 shows an exemplary curve of RF power 620 vs. etch rates 600. When RF power is less than pwₘₐₓ, 610, increasing power supply will increase ion bombardment energy and so the etch rate. However, when plasma density reaches a certain level, further increase of RF power will increase the plasma density. The ion collisions will increase. This causes reduction of the ion energy; hence, reduce the etch rate.

The similar theory applies to gas flow vs. etch rates. When gas flow is less than gₘₐₓ, increase gas flow will increase the reactance and so the etch rate. However, when gas flow reaches a certain level, further increase of gas flow will increase the plasma density. The ion collisions will increase. So the ion energy will decrease and so the etch rate. Assume, etch rate is the function of gas flow g, and RF power pw. The etch rate needed is E_{control}(pw, g). At tᵢ time, etch rate is Eᵢ(pw, g). ΔEᵢ (pw, g)=E_{control} (pw, g)−Eᵢ (pw, g). ΔEᵢ are to be entered to the control system to approximate the etch rate needed at tᵢ time. For more accurate control, ΔΔEᵢ can be used to compensate with the changes of equipment, environment, and other factors. ΔEᵢ=E_{control}−Eᵢ,+ΔΔE. By using the variable parameters, the system can meet the requirements and uniform process results.

Multiple Variable Parameter Controls

Sometimes, single variable parameter control is not sufficient to reach the requirements. In addition, adjusting one parameter, sometimes leads to unwanted changes of another parameter. In these cases, multiple parameters may need to be adjusted.

Assume a control parameter is f. f(T, d, g, t, pw, . . . ) is the function of temperature T, distance d between 160 and 110, gas flow g, etch time t, RF power pw, plasma density pd, and others. Not all of these parameters need to be variables at the same time. The control parameter needed is f_{control}(T, d, g, t, pw, . . . ). At tᵢ time, the parameter is fᵢ(T, d, g, t, pw, . . . ). Δfᵢ(T, d, g, t, pw, . . . )=f_{control}(T, d, g, t, pw, . . . )−fᵢ(T, d, g, t, pw, . . . ) are to be entered to the control system to approximate the control parameter needs at to time. For more accurate control, ΔΔfᵢ can be used to compensate with the changes of equipment, environment, and other factors. Δf₁=f_{control}−ΔΔf. By using the variable parameters, the system can meet the requirements and uniform process results.

The applications of the present invention will be further understood by the following detailed examples.

Using Several Different Recipes

One easy way to implement the concept of the variable parameter control is to discrete the compensation parameters and input them into several different recipes. The principal idea is to discrete the parameter based on the magnitude of the parameter changes to approximate the needed compensations. Followings are detailed procedures. Temperature compensation is used as an example.

1. Determine the adjustable parameters. For example: electrode temperature T.

2. Find the adjustment amount for the parameter ΔT. ΔT can be found by real time measurement and control, dynamic characteristics generated by theoretical analysis, experimental data, and/or simulation. See FIG. 2.

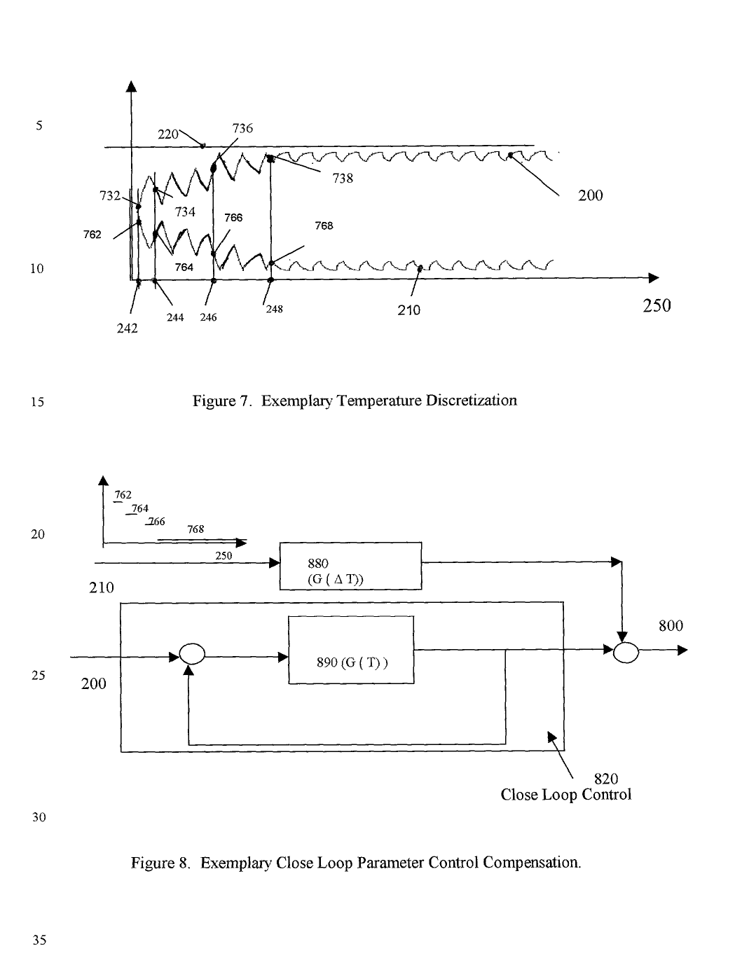

3. Discretize the compensation parameters. FIG. 7 shows temperatures at four discrete level Tₐ 732, T_{b,} 734, T_{c,} 736 and T_{d} 738 corresponding to time t_{a,} 242, t_{b,} 244, t_{c} 246, and t_{d} 248 respectively. Find ΔT_{a 762, ΔT}_{b,} 764, ΔT_{c}, 766 and ΔT_{d} 768.

4. Make recipes according to the variables. Following is an example of the recipes. They are executed consequently.

a. 30 mt/T800 W/B1000 W/180Ar/12C₄F₈/9O₂/25N₂/T40° C./B(20+ΔTₐ (762))° C./60 s/d 1″ for substrates starting tₐ

b. 30 mt/T800 W/B1000 W/180Ar/12C₄F₈/9O₂/25N₂/T40° C./B(20+ΔT_{b} (764))° C./60 s/d 1″ for substrates starting t_{b}

c. 30 mt/T800 W/B1000 W/180Ar/12C₄F₈/9O₂/25N₂/T40° C./B(20+ΔT_{c} (766))° C./60 s/d 1″ for substrates starting t_{c}

d. 30 mt/T800 W/B1000 W/180Ar/12C₄F₈/9O₂/25N₂/T40° C./B(20+ΔT_{b} (768))° C./60 s/d 1″ for substrates starting t_{b}

5. Executing these recipes either from a code or manually. The close loop control block diagram 820 with compensation transfer function 880, system transfer function 890, output 800 is shown in FIG. 8.

6. Control system will execute above recipes accordingly.

Compensation Embedded in the System

1. Determine the adjustable parameters. For example: the distance d between the substrate and electrode opposite to the substrate.

2. Find the adjustment delta for the parameter Δd (410). Δd can be found by real time measurement and control, dynamic characteristics generated by analysis, experimental data, and/or simulation. See FIG. 4.

3. Make a recipe with constant initial parameters. Following is an example of the recipe. They are shown in the process control windows. 30 mt/T800 W/B1000 W/180Ar/12C₄F₈/9O₂/25N₂/T40° C./60 s/d 1″ for all substrates

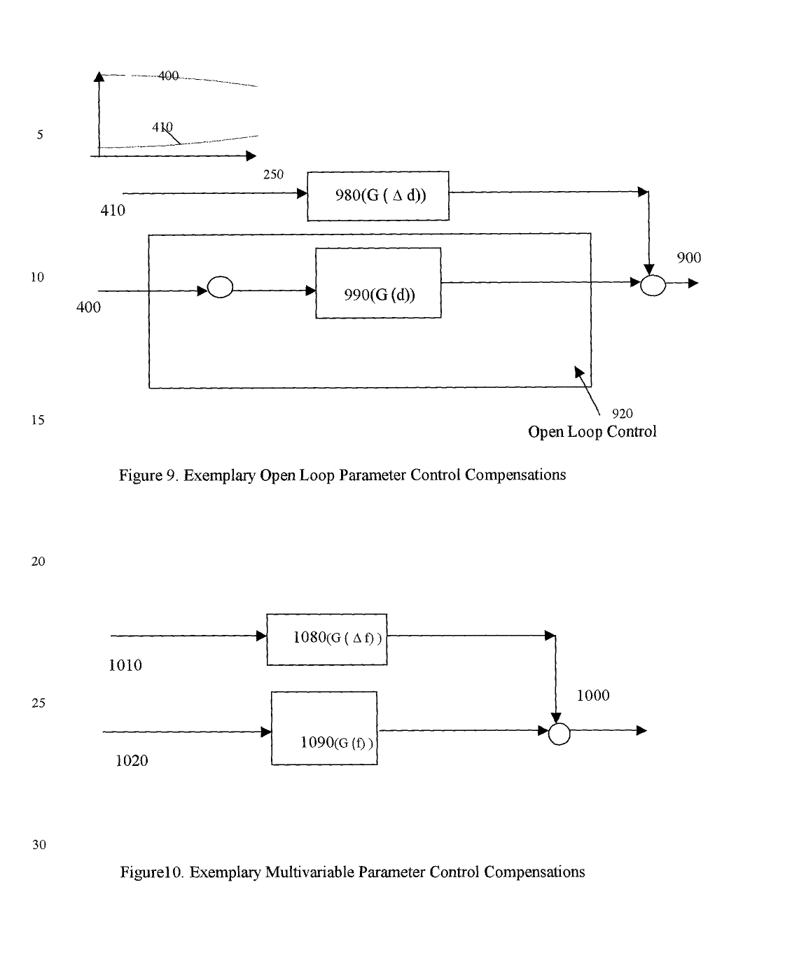

4. Make code for adding Δd. The control block diagram 920 is shown in FIG. 9. Where 980 is compensation transfer function, 990 is system transfer function, and 900 is output. The real distance executed is (d(400)+Δd(410))″ for above example.

5. Control system will perform Δdᵢ+dᵢ at tᵢ time.

Compensation Shown in the Control Windows

1. Determine the adjustable parameters. For example for a main parameter f 1020.

2. Find the adjustment amount for the parameter Δf. Δf can be found by real time measurement and control, dynamic characteristics generated by analytical analysis, experimental data, and/or simulation.

3. Make a recipe with constant parameters. Followings are example of the recipes. They are shown in the process control windows. 30 mt/T800 W/B1000 W/180Ar/12C₄F₈/9O₂/25N₂/T40° C./60 s/d 1″ for all substrates.

4. Make code for add Δfᵢ, 1010.

5. Control system will perform Δfᵢ+fᵢ. The control block diagram is shown in FIG. 10. Where 1080 is compensation transfer function, 1090 is system transfer function, and 1000 is output.

6. Out put this number to the control windows.

Above procedures are examples. It is not required to follow the same orders as shown.

The implementation of the present invention has several benefits as follows: it allows high substrate-to-substrate uniformity. It can increase throughput. It allows tight process control and tight process specification. It can reduce the cost of the ownership.

While this invention has been described in terms of several preferred embodiments. However, it will be readily apparent to those skilled in the art that there are alterations, permutations, and equivalents, which fall within the spirit of this invention. It should also be noted that there are many alternative ways of implementing the methods and techniques of the present invention. It is therefore intended that the following appended claims be interpreted as including all such alterations, permutations, and equivalents as fall within the true spirit and scope of the present invention.

What is claimed is:

1. A method of processing semiconductor substrates with variable parameter control include:
determining the adjustable parameters;
finding the adjustment delta for the parameter;
designing code and/or hardware for executing the parameter adjustments in a process and control system; and
processing a substrate in the processing chamber with an adjusted parameter.

2. The method recited in claim 1, wherein said parameter is pressure or pressure counts.

3. The method recited in claim 1, wherein said parameter is temperature or temperature counts.

4. The method recited in claim 1, wherein said parameter is processing time.

5. The method recited in claim 1, wherein said parameter is RF power or electrical power.

6. The method recited in claim 1, wherein said parameter is amount of the gas flow rate or chemistry input.

7. The method recited in claim 1, wherein said parameter is volume.

8. The method recited in claim 1, wherein said parameters are electric parameters.

9. The method recited in claim 1, wherein said parameter is optical signals.

10. The method recited in claim 1, wherein said parameter is any parameter controlled.

11. The method recited in claim 1, wherein said parameter is any combination of any parameters controlled.

12. The method recited in claim 1, wherein said the adjustment/compensation amount for the parameter is determined by real time measurements.

13. The method recited in claim 1, wherein said the adjustment/compensation amount for the parameter is determined by dynamic characteristics generated by analytical analysis.

14. The method recited in claim 1, wherein said the adjustment/compensation amount for the parameter is determined by experimental data.

15. The method recited in claim 1, wherein said the adjustment/compensation amount for the parameter is determined by simulation results.

16. The method recited in claim 1, wherein said parameter variable control is imbedded in the hardware and/or control system.

17. The method recited in claim 1, wherein said parameter variable control is adjusted by software.

18. The method recited in claim 1, wherein said parameter variable control is appeared in a process control window.

19. The method recited in claim 1, wherein said parameter variable control is using recipes with different amount of the same control parameter executed manually and/or automatically.

20. A processing method of processing substrate, comprising
a vacuum chamber;
a gap variable device/system or a volume variable device/system
a control system
detecting the volume of the processing chamber, comparing reference characteristics, varying chamber volume by changing the dimension of chamber axis direction, which is the distance from electrode to substrate, or changing the other dimension of the chamber, or varying volume by using robber like material.
